(19) United States
(12) Patent Application Publication
(10) Pub. No.: US 2026/0246709 A1
(43) Pub. Date: Aug. 20, 2026

(54) METHODS AND DEVICES FOR EXECUTING AI SERVICE, NETWORK ELEMENTS, STORAGE MEDIUM AND CHIP

(71) Applicant: Beijing Xiaomi Mobile Software Co., Ltd., Beijing (CN)

(72) Inventors: Dong CHEN, Beijing (CN); Zhibin HE, Beijing (CN)

(73) Assignee: Beijing Xiaomi Mobile Software Co., Ltd., Beijing (CN)

(21) Appl. No.: 18/859,383

(22) PCT Filed: Apr. 25, 2022
(86) PCT No.: PCT/CN2022/089128

§ 371 Date: Oct. 23, 2024

(51) Int. Cl. H04L 41/16; H04L 12/14

(52) U.S. Cl. CPC H04L 41/16; H04L 12/1407

(57) ABSTRACT

A method for executing an artificial intelligence (AI) service, the method includes: receiving an AI service request message, where the AI service request message is configured to indicate an AI service requested by a user equipment (UE); determining an AI service execution policy according to attribute information of a plurality of user plane function (UPF) network elements and the AI service request message; and controlling a target UPF network element to execute the AI service according to the AI service execution policy, where the target UPF network element is one or more of the plurality of UPF network elements.

### CROSS-REFERENCE TO RELATED APPLICATIONS

The present application is a U.S. National Stage of International Application No. PCT/CN2022/089128, filed on Apr. 25, 2022, the contents of all of which are incorporated herein by reference in their entirety for all purposes.

### BACKGROUND OF THE INVENTION

Currently, artificial intelligence (AI) technology has become one of the core technologies of fifth-generation mobile communication system (5G) networks, and there is a high degree of overlap in typical application scenarios between 5G networks and AI technology.

### SUMMARY OF THE INVENTION

The present disclosure relates to the field of communications, and in particular, to methods and devices for executing an artificial intelligence (AI) service, network elements, a storage medium, and a chip. Methods and devices for executing an artificial intelligence (AI) service, network elements, a storage medium, and a chip are provided according to the present disclosure.

According to a first aspect of an embodiment of the present disclosure, a method for executing an AI service performed by a session management function (SMF) network element is provided. The method includes: receiving an AI service request message, where the AI service request message is configured to indicate an AI service requested by a user equipment (UE); determining an AI service execution policy according to attribute information of a plurality of user plane function (UPF) network elements and the AI service request message; and controlling a target UPF network element to execute the AI service according to the AI service execution policy, where the target UPF network element is one or more of the plurality of UPF network elements.

According to a second aspect, a method for executing an AI service performed by a UPF is provided. The method includes: receiving an AI service execution policy sent by a SMF network element, where the AI service execution policy is determined by the SMF network element according to attribute information of a plurality of UPF network elements and an AI service request message, and the AI service request message is configured to indicate an AI service requested by a UE; and executing the AI service according to the AI service execution policy.

According to a third aspect, a method for executing an AI service performed by a UE is provided. The method includes: sending an AI service request message to a SMF network element, where the AI service request message is configured to indicate an AI service requested by the UE, the AI service request message is configured to instruct the SMF network element to determine an AI service execution policy according to attribute information of a plurality of UPF network elements and the AI service request message and control a target UPF network element to execute the AI service according to the AI service execution policy, and the target UPF network element is one or more of the plurality UPF network elements; and receiving a service execution result of the AI service sent by the SMF network element.

According to a fourth aspect, a SMF network element is provided, including: one or more processors; and a memory that stores processor-executable instructions, where the one or more processors are configured to perform the method according to any one of items in the first aspect when executing the processor-executable instructions.

According to a fifth aspect, a UPF network element is provided, including: one or more processors; and a memory that stores processor-executable instructions, where the one or more processors are configured to perform the method according to any one of items in the second aspect when executing the processor-executable instructions.

According to a sixth aspect, a UE is provided, including: one or more processors; and a memory that stores processor-executable instructions, where the one or more processors are configured to perform the method according to any one of items in the third aspect when executing the processor-executable instructions.

It is to be understood that the general description and the following detailed description are merely illustrative and explanatory and are not intended to limit the present disclosure.

### BRIEF DESCRIPTION OF DRAWINGS

The accompanying drawings herein are incorporated into and constitute a part of the specification, which illustrates embodiments that are consistent with the present disclosure and are used together with the specification to explain the principles of the present disclosure.

FIG. 1 is a flowchart of a method for executing an artificial intelligence (AI) service according to an example.

FIG. 2 is a flowchart of a method for executing an AI service according to an example.

FIG. 3 is a flowchart of a method for executing an AI service according to an example.

FIG. 4 is a flowchart of a method for executing an AI service according to an example.

FIG. 5 is a flowchart of a method for executing an AI service according to an example.

FIG. 6 is a flowchart of a method for determining a policy according to an example.

FIG. 7 is a flowchart of a method for executing an AI service according to an example.

FIG. 8 is a flowchart of a method for executing an AI service according to an example.

FIG. 9 is a flowchart of a method for executing an AI service according to an example.

FIG. 10 is a flowchart of a method for executing an AI service according to an example.

FIG. 11 is a block diagram of a device for executing an AI service according to an example.

FIG. 12 is a block diagram of a device for executing an AI service according to an example.

FIG. 13 is a block diagram of a device for executing an AI service according to an example.

FIG. 14 is a block diagram of a device for executing an AI service according to an example.

FIG. 15 is a block diagram of a device for executing an AI service according to an example.

### DETAILED DESCRIPTION OF THE INVENTION

Example embodiments will be described in detail herein, and examples of which are represented in the accompanying drawings. When the following description refers to the accompanying drawings, unless otherwise indicated, the same numbers in different accompanying drawings represent the same or similar elements. The embodiments described the following example do not represent all the embodiments consistent with the present disclosure. Rather, they are simply examples of devices and methods consistent with some aspects of the present disclosure, as detailed in the appended claims.

It may be understood that “a plurality of” mentioned in the present disclosure means two or more, and other quantifiers are similar. “And/or” herein describes the correspondence of corresponding objects, indicating three types of relationships. For example, A and/or B, may be expressed as: A exists alone, A and B exist concurrently, B exists alone. The character “/” generally indicates an “or” relationship between the contextual objects. The singular forms “a/an”, “said” and “the” are intended to include the plural forms as well, unless the context clearly indicates otherwise.

It may further be understood that although the terms “first”, “second”, etc. are used to describe various information, but these information is not to be limited to these terms. These terms are merely used to distinguish information of the same type from each other, and do not indicate a specific order or importance. In fact, the expressions such as “first” and “second” may be used interchangeably. For example, “first information frame” may also be referred to as “second information frame” without departing from the scope of the present disclosure. Similarly, “second information frame” may also be referred to as “first information frame”.

It may further be understood that, although operations are depicted in the accompanying drawings in a particular order, it is not to be construed that such operations need to be performed in the particular order shown or in a sequential order, or all illustrated operations need to be performed to achieve desirable results. In certain circumstances, multitasking and parallel processing may be advantageous.

It should be noted that all actions to obtain signals, information or data in this application are carried out in accordance with the appropriate data protection regulations and policies of the country where they are located and with the authorization of the owners of the respective devices.

In the related art, artificial intelligence (AI) technology has become one of the core technologies of fifth-generation mobile communication system (5G) networks, and there is a high degree of overlap in typical application scenarios between 5G networks and AI technology. However, due to the widespread application of AI technology occurring later than the establishment of the 5G network architecture, relevant research was initiated only after the 5G network architecture was determined. Therefore, in the related art, the application of AI technology based on 5G networks typically belongs to an external application model, which means that optimizations and modifications are made on traditional network architectures. This approach lacks a unified AI service operation and technical framework, which often involves a simple overlay of AI services onto existing network processes, failing to achieve a tight coupling of AI technology with 5G networks.

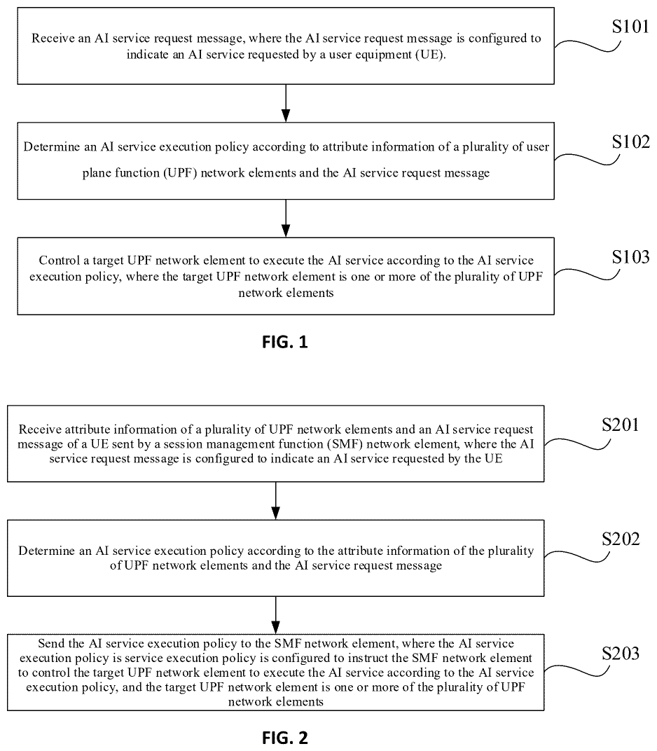

FIG. 1 is a flowchart of a method for executing an AI service according to an example. As shown in FIG. 1, the method for executing an AI service is performed by a session management function (SMF) network element. The method includes the steps as follows.

In step S101, an AI service request message is received, where the AI service request message is configured to indicate an AI service requested by a user equipment (UE).

For example, the AI service request message may be initiated by the UE. In an embodiment, when the UE needs to request to invoke a certain AI service from the core network of the 5G network, the UE generates the AI service request message. The AI service request message may at least include AI service parameters for indicating the AI service requested by the UE. For example, the AI service parameter may include at least one of an AI service identifier (ID), an AI service type, and AI data used for executing the AI service. Optionally, the AI service request message may also include other information, such as a data network name (DNN), etc.

The UE may send the AI service request message to a radio access network (RAN), which may also be referred as to an (R)AN. The RAN receives the AI service request message and then forwards the AI service request message to an access and mobility management function (AMF) network element. The AMF network element receives the AI service request message and then forwards the AI service request message to the SMF network element, which may be understood that the UE sends the AI service request message to the RAN and then transparently transmits the AI service request message to the SMF network element via the RAN and the AMF network element sequentially.

In Step S102, an AI service execution policy is determined according to attribute information of a plurality of user plane function (UPF) network elements and the AI service request message.

For example, for any UPF network element, the attribute information of the UPF network element may include an AI service that can be supported by the UPF network element. In this way, the AI service that can be supported by each UPF network element among the plurality of UPF network elements can be determined according to the attribute information of the plurality of UPF network elements. And the AI service requested by the UE can be determined according to the AI service request message. Hence, one or more UPF network elements that can be used for executing the AI service requested by the UE may be determined as the target UPF network element(s) described below, to determine corresponding AI service execution policy.

In an embodiment, the SMF network element receives the AI service request message, and may query a network repository function (NRF) network element to obtain the attribute information of the plurality of UPF network elements. For example, a UPF list is stored in this NRF network element. The UPF list is obtained by querying the NRF network element, so that the plurality of UPF network elements may be determined, and the attribute information of the plurality of UPF network elements may be obtained. The plurality of UPF network elements may be some or all UPF network elements in the UPF list.

After obtaining the attribute information of the plurality of UPF network elements, the SMF network element may determine the AI service execution policy according to the attribute information of the plurality of UPF network elements and the AI service request message. For example, the AI service execution policy may be a policy control and charging (PCC) rule, which may include at least one or more of the followings: an identifier of the PCC rule, an identifier of the target UPF network element assigned to the AI service, and a priority of the target UPF network element, etc.

In step S103, a target UPF network element is controlled to execute the AI service according to the AI service execution policy, where the target UPF network element is one or more of the plurality of UPF network elements.

For example, after receiving the AI service execution policy, the SMF network element establishes a connection with the target UPF network element(s) and sends the AI service execution policy to the target UPF network element(s), and the target UPF network element(s) executes/execute the AI service requested by the UE according to the AI service execution policy.

In this way, the corresponding AI service execution policy can be generated for the AI service requested by the UE, and the AI service can be executed by scheduling one or more UPF network elements. This provides a workflow for applying AI services based on the 5G core network, enabling a tight coupling of AI technology and the 5G network.

FIG. 2 is a flowchart of a method for executing an AI service according to an example. As shown in FIG. 2, the method for executing an AI service is performed by a PCF network element. The method includes steps as follows.

In step S201, attribute information of a plurality of UPF network elements and an AI service request message of a UE sent by an SMF network element are received, where the AI service request message is configured to indicate an AI service requested by the UE.

For example, the AI service request message and the method of the UE sending the AI service request message to the SMF network element are the same as those in step S101, reference may be made to step S101 and will not be repeated.

After obtaining the attribute information of the plurality of UPF network elements, the SMF network elements sends the attribute information of the plurality of UPF network elements and the AI service request message sent by the UE to the PCF network element.

In step S202, an AI service execution policy is determined according to the attribute information of the plurality of UPF network elements and the AI service request message.

For example, after receiving the attribute information of the plurality of UPF network elements and the AI service request message sent by the SMF network element, the PCF network element determines one or more UPF network elements that can be used for executing the AI service requested by the UE as the target UPF network element(s) by analyzing the attribute information of the plurality of UPF network elements and the AI service request message, and determines the corresponding AI service execution policy. The AI service execution policy may be the PCC rules, which is the same as that described in step S102 and will not be repeated.

In step S203, the AI service execution policy is sent to the SMF network element, where the AI service execution policy is configured to instruct the SMF network element to control the target UPF network element(s) to execute the AI service according to the AI service execution policy, and the target UPF network element(s) is/are one or more of the plurality of UPF network elements.

For example, after obtaining the AI service execution policy, the SMF network element establishes a connection with the target UPF network element(s) and sends the AI service execution policy to the target UPF network element(s), and the target UPF network element(s) executes/execute the AI service requested by the UE according to the AI service execution policy.

In this way, the corresponding AI service execution policy can be generated for the AI service requested by the UE, and the AI service can be executed by scheduling one or more UPF network elements, thereby providing a workflow for applying the AI service based on a 5G core network, such that tight coupling between an AI technology and a 5G network can be achieved.

FIG. 3 is a flowchart of a method for executing an AI service according to an example. As shown in FIG. 3, the method for executing the AI service is performed by a UPF network element. The method includes steps as follows.

In step S301, an AI service execution policy sent by an SMF network element is received, where the AI service execution policy is determined by the SMF network element according to attribute information of a plurality of UPF network elements and an AI service request message, and the AI service request message is configured to indicate an AI service requested by a UE.

For example, the AI service request message and the method of the UE sending the AI service request message to the SMF network element are the same as those in step S101, reference may be made to step S101 and will not be repeated. After the SMF network element receives the AI service request message, the method for determining the AI service execution policy may refer to steps S102 and S202 and will not be repeated.

In step S302, the AI service is executed according to the AI service execution policy.

The AI service execution policy may be the PCC rules, which is the same as the PCC rules described in step S102 and will not be repeated. In a case where a plurality of target UPF network elements are used for executing the AI service execution policy, the plurality of target UPF network elements include a primary UPF network element and at least one secondary UPF network element. The SMF network element may first send the AI service execution policy to the primary UPF network element, and the primary UPF network element may issue the AI service execution policy to each secondary UPF network element, such that the primary UPF network element and the secondary UPF network elements execute the AI service according to the AI service execution policy assigned thereto.

Optionally, the primary UPF network element may receive an execution result obtained after the secondary UPF network elements among the plurality of target UPF network elements execute the AI service according to the AI service execution policy. Optionally, the primary UPF network element may receive execution result(s) obtained by the secondary UPF network element(s) among the plurality of target UPF network elements executing the AI service according to the AI service execution policy. The execution result of the primary UPF network element and the execution result(s) of the secondary UPF network element(s) are aggregated to obtain the service execution result of the AI service.

In this way, the corresponding AI service execution policy can be generated for the AI service requested by the UE, and the AI service can be executed by scheduling one or more UPF network elements. This provides a workflow for applying AI services based on the 5G core network, enabling a tight coupling of AI technology with the 5G network.

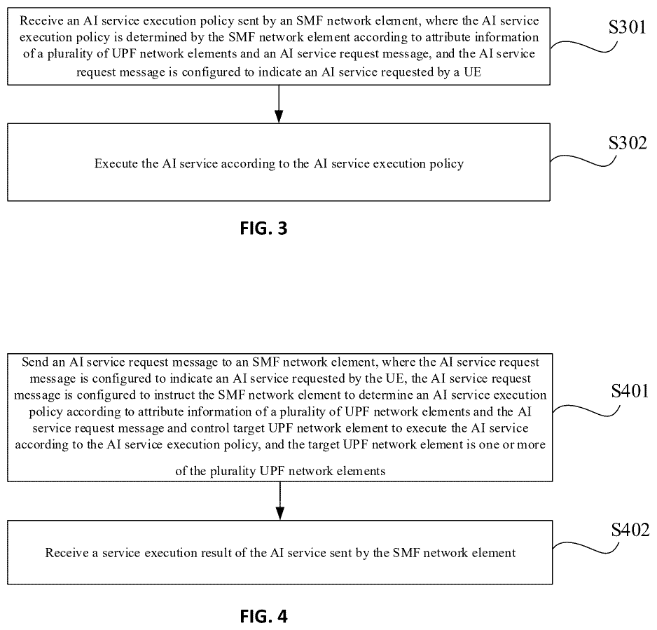

FIG. 4 is a flowchart of a method for executing an AI service according to an example. As shown in FIG. 4, the method for executing an AI service is performed by a UE. The method includes steps as follows.

In step S401, an AI service request message is sent to an SMF network element, where the AI service request message is configured to indicate an AI service requested by the UE, the AI service request message is configured to instruct the SMF network element to determine an AI service execution policy according to attribute information of a plurality of UPF network elements and the AI service request message and control target UPF network element(s) to execute the AI service according to the AI service execution policy, and the target UPF network element(s) is/are one or more of the plurality UPF network elements.

For example, the AI service request message and the method of the UE sending the AI service request message to the SMF network element are the same as those in step S101, reference may be made to step S101 and will not be repeated. After the SMF network element receives the AI service request message, the method for determining the AI service execution policy may refer to steps S102 and S202 and will not be repeated. The method of the target UPF network element executing the AI service according to the AI service execution policy may refer to steps S301 and S302 and will not be repeated.

In step S402, a service execution result of the AI service sent by the SMF network element is received.

For example, the target UPF network element executes the AI service according to the AI service execution policy and then obtains the service execution result of the AI service. Then, the target UPF network element sends the service execution result to the SMF network element. The SMF network element sends the service execution result to the UE. The SMF network element sending the service execution result to the UE may include as follows. The SMF network element first sends the service execution result to an AMF network element; the AMF network element forwards the service execution result to a RAN; and the RAN forwards the service execution result to the UE, such that the UE obtains the service execution result of the AI service.

In this way, the corresponding AI service execution policy can be generated for the AI service requested by the UE, and the AI service can be executed by scheduling one or more UPF network elements. This provides a workflow for applying AI services based on the 5G core network, enabling a tight coupling of AI technology with the 5G network.

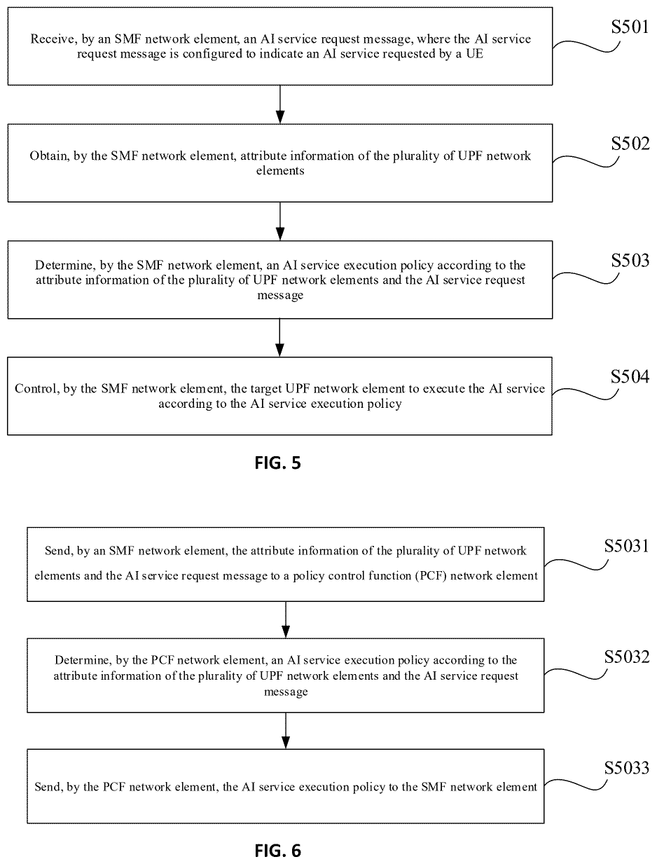

FIG. 5 is a flowchart of a method for executing an AI service according to an example. As shown in FIG. 5, the method for executing an AI service includes steps as follows.

In step S501, an SMF network element receives an AI service request message, where the AI service request message is configured to indicate an AI service requested by a UE.

The AI service request message may be initiated by the UE. In an embodiment, when the UE needs to request to invoke a certain AI service from the core network of the 5G network, the UE generates the AI service request message. The AI service request message may at least include AI service parameters for indicating the AI service requested by the UE. For example, the AI service parameters may include at least one of an AI service ID, an AI service type, and AI data used for executing the AI service. The types of AI services may include: video AI services, such as image recognition; audio AI services, such as speech recognition; text AI services, such as natural language processing, etc.

Optionally, the AI service request message may also include other information, e.g., one or more of a DNN, device information of the UE, user information of the UE, and an access type. The device information of the UE may include one or more of a device ID, a device model, and device position information.

The UE may send the AI service request message to the RAN. The RAN receives the AI service request message and then forwards the AI service request message to an AMF network element. The AMF network element receives the AI service request message and then forwards the AI service request message to the SMF network element, which means that the UE sends the AI service request message to the RAN and then transparently transmits the AI service request message to the SMF network element via the RAN and the AMF network element sequentially.

In addition, after receiving the AI service request message, the AMF network element may store the AI data in the AI service request message in an unstructured data storage network function (UDSF) network element for subsequent processes. The UPF network element invokes the AI data from the UDSF network element while executing the AI service. Alternatively, after receiving the AI service request message, the SMF network element may store the AI data in the AI service request message in the UDSF network element.

In step S502, the SMF network element obtains attribute information of the plurality of UPF network elements.

For example, after receiving the AI service request message, the SMF network element may query the NRF network element to obtain the attribute information of the plurality of UPF network elements. The method of the SMF network element obtaining the attribute information of the plurality of UPF network elements from the NRF network element may refer to step S102 and will not be repeated.

For any UPF network element, the attribute information of the UPF network element may include: an AI service ID, an AI service type and other information of an AI service that can be supported by the UPF network element, as well as position information of the UPF network element.

In step S503, the SMF network element determines an AI service execution policy according to the attribute information of the plurality of UPF network elements and the AI service request message.

FIG. 6 is a flowchart of a method for determining a policy according to an example. As shown in FIG. 6, the step S503 may include steps as follows.

In step S5031, an SMF network element sends the attribute information of the plurality of UPF network elements and the AI service request message to a PCF network element.

In step S5032, the PCF network element determines an AI service execution policy according to the attribute information of the plurality of UPF network elements and the AI service request message.

For example, after receiving the attribute information of the plurality of UPF network elements sent by the SMF network element and the AI service request message, the PCF network element determines one or more UPF network elements that can be used to execute the AI service requested by the UE as the target UPF network element(s) by analyzing the attribute information of the plurality of UPF network elements and the AI service indicated by the AI service request message, and determines the corresponding AI service execution policy. The AI service execution policy may be the PCC rule, which may include at least one or more of the followings: a rule identifier of the PCC rule, an identifier of the target UPF network element assigned to the AI service, or a priority of the target UPF network element, etc.

For example, since the AI service request message may include the AI service ID and AI service type, and the attribute information of the UPF network elements may include the AI service ID, the AI service type and other information of the AI service that can be supported by the UPF, the preceding step of determining the AI service execution policy may include the following steps.

Firstly, according to AI services supported by the plurality of UPF network elements, at least one target UPF network element from the plurality of UPF network elements that matches the AI service identifier(ID) and the AI service type is determined.

Secondly, a priority of the at least one target UPF network element is determined according to the AI service supported by the at least one target UPF network element.

For example, the AI service ID and the AI service type of the AI service that can be supported by each UPF network element among the plurality of UPF network elements are compared with the AI service ID and the AI service type in the AI service request message of the UE to determine at least one target UPF network element matching the AI service request message.

After the at least one target UPF network element is determined, the priority of the at least one target UPF network element may be determined according to the AI service that can be supported by each target UPF network element and the AI service requested by the AI service request message. The priority of the UPF network element may include whether the UPF network element is a primary UPF network element or a secondary UPF network element, also a priority of an execution order of the at least one target UPF network element when executing the AI service.

Optionally, in the process of determining at least one target UPF network element matching the AI service request message, the position of the UE may also be considered. As described, the AI service request message may also include device position information. The attribute information of the UPF network element may also include position information of the UPF network element. Therefore, the position information, the AI service ID and the AI service type of the AI service that can be supported by each UPF network element among the plurality of UPF network elements may be compared with the AI service ID, the AI service type and the device position information in the AI service request message of the UE to determine one or more UPF network elements that match all the listed information as the target UPF network element(s).

After determining the AI service execution policy, the PCF network element may store the AI service execution policy in a user data repository (UDR), and then step 5033 is performed.

In step S5033, the PCF network element sends the AI service execution policy to the SMF network element.

Returning to FIG. 5, in step S504, the SMF network element controls the target UPF network element(s) to execute the AI service according to the AI service execution policy.

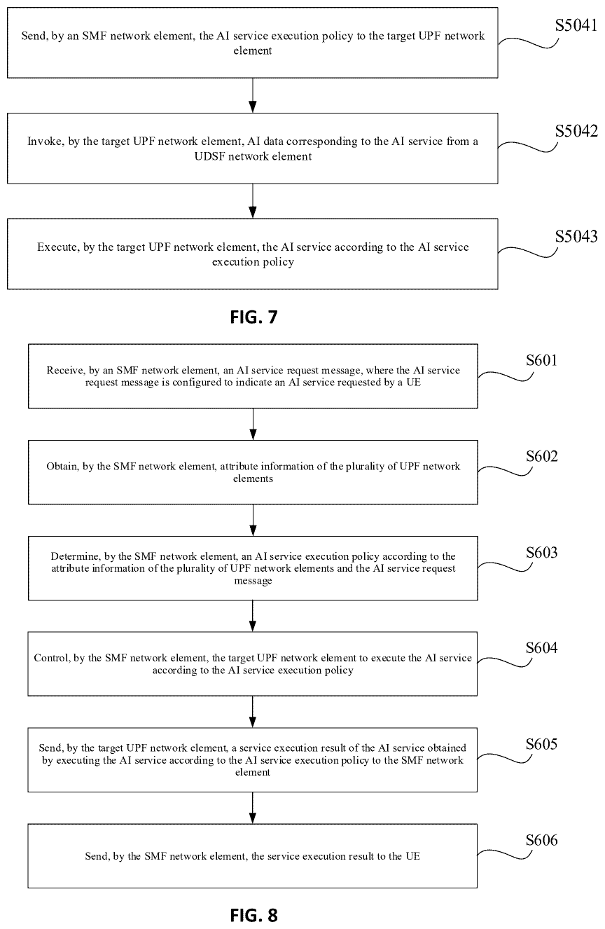

FIG. 7 is a flowchart of a method for executing an AI service according to an example. As shown in FIG. 7, the step S504 may include the following steps.

In step S5041, an SMF network element sends the AI service execution policy to the target UPF network element(s).

In step S5042, the target UPF network element(s) invokes/invoke AI data corresponding to the AI service from a UDSF network element.

In step S5043, the target UPF network element(s) executes/execute the AI service according to the AI service execution policy.

The target UPF network element may be one or more. In a case where there are a plurality of target UPF network elements, the plurality of target UPF network elements may include a primary UPF network element and at least one secondary UPF network element. The SMF network element may first send the AI service execution policy to the primary UPF network element, and the primary UPF network element may issue the AI service execution policy to each secondary UPF network element, such that the primary UPF network element and the secondary UPF network elements execute the AI service according to the AI service execution policy assigned thereto.

For example, it may be understood that the AI service may be a single AI service or a plurality of AI services. In a case where there are a plurality of AI services, the plurality of AI services may jointly complete an AI function, where each AI service participates in different AI sub-functions, which may be a single AI sub-function or a combination of a plurality of AI sub-functions. Alternatively, the plurality of AI services may jointly complete a plurality of AI functions. The UPF network elements may perform distributed tasks such as federated learning through an N9 interface of 5G, and store output data in the UDSF network element to implement data sharing between the UPF network elements.

In a possible implementation, in a case where the UE requests a plurality of AI services, the plurality of AI services may be executed by the primary UPF network element and the at least one secondary UPF network element respectively. The primary UPF network element and the secondary UPF network element(s) execute one or more of the plurality of AI services according to the AI service supported by the primary UPF network element and the secondary UPF network element(s). For example, different AI services are used to execute different AI algorithms. For example, AI service 1 is configured to execute a support vector machine (SVM) algorithm, AI service 2 is configured to execute random forest, AI service 3 is configured to execute a principal component analysis (PCA) dimensionality reduction algorithm, and AI service 4 is configured to execute a K-means clustering algorithm, etc. In this way, the plurality of UPF network elements can execute a plurality of different algorithms in a distributed manner through the plurality of AI services. Optionally, in this implementation, the priorities of the target UPF network elements described may be determined according to an execution order in which different UPF network elements execute different algorithms.

Alternatively, in another possible implementation, in a case where the UE requests an AI service, the primary UPF network element and the secondary UPF network elements may be used to execute a part of the AI service respectively. For example, the AI algorithm corresponding to the AI service is divided into a plurality of parts (or steps), and the primary UPF network element and the secondary UPF network elements execute one or more of the plurality of parts (or execute one or more of a plurality of steps, respectively), respectively. Optionally, the priorities of the target UPF network elements described may be an execution order in which different UPF network elements execute different algorithms. Optionally, in this implementation, the priorities of the target UPF network elements described may be determined according to an order of executing a plurality of parts (or steps) according to this AI algorithm.

In this way, the corresponding AI service execution policy can be generated for the AI service requested by the UE, and the AI service can be executed by scheduling one or more UPF network elements. This provides a workflow for applying AI services based on the 5G core network, enabling a tight coupling of AI technology with the 5G network.

FIG. 8 is a flowchart of a method for executing an AI service according to an example. As shown in FIG. 8, the method for executing an AI service includes the following steps.

In step S601, an SMF network element receives an AI service request message, where the AI service request message is configured to indicate an AI service requested by a UE.

In step S602, the SMF network element obtains attribute information of the plurality of UPF network elements.

In step S603, the SMF network element determines an AI service execution policy according to the attribute information of the plurality of UPF network elements and the AI service request message.

In step S604, the SMF network element controls the target UPF network element to execute the AI service according to the AI service execution policy, where the target UPF network element is one or more of the plurality of UPF network elements.

The steps S601 to S604 in this method are the same as the steps S501 to S504, reference may be made to the steps S501 to step S504 and will not be repeated.

In step S605, the target UPF network element sends a service execution result of the AI service obtained by executing the AI service according to the AI service execution policy to the SMF network element.

For example, as described in steps S5041 to S5042, in a case where there are a plurality of target UPF network elements, a primary UPF network element among the target UPF network elements receives the execution result(s) obtained by the secondary UPF network element(s) among the plurality of target UPF network elements executing the AI service according to the AI service execution policy.

The primary network element aggregates an execution result of the primary UPF network element and the execution result(s) of the secondary UPF network element(s) to obtain a service execution result of the AI service. It can be understood that the execution result of the primary UPF network element and the execution results of the secondary UPF network elements may be used as a part of the execution result of the AI service. The final service execution result needs to be obtained by aggregating the respective execution results by the primary UPF network element. For example, since the AI data corresponding to the AI service invoked by the UPF network element in the course of executing the AI service is stored in the UDSF network element and is unstructured data, the respective UPF network elements may optionally store their own execution results in the UDSF network element, such that the primary UPF network element needs to structure the execution results in the process of aggregating the execution results, thereby obtaining an aggregated service execution result.

In step S606, the SMF network element sends the service execution result to the UE.

For example, the SMF network element may send this service execution result to the AMF network element, the AMF network element forwards the service execution result to the RAN, and the RAN then forwards the service execution result to the UE.

In this way, the corresponding AI service execution policy can be generated for the AI service requested by the UE, and the AI service can be executed by scheduling one or more UPF network elements. This provides a workflow for applying AI services based on the 5G core network, enabling a tight coupling of AI technology with the 5G network.

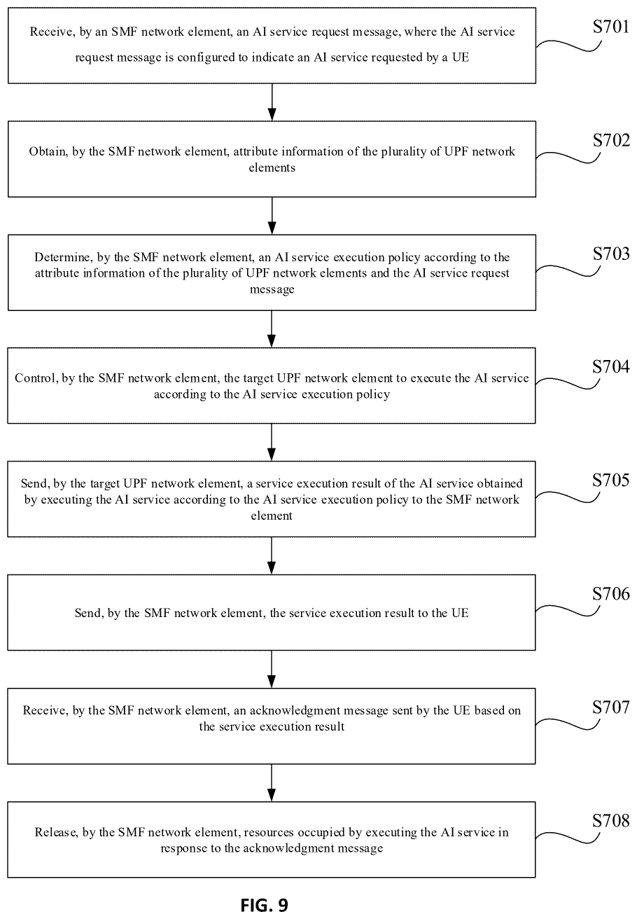

FIG. 9 is a flowchart of a method for executing an AI service according to an example. As shown in FIG. 9, the method for executing an AI service includes the following steps.

In step S701, an SMF network element receives an AI service request message, where the AI service request message is configured to indicate an AI service requested by a UE.

In step S702, the SMF network element obtains attribute information of a plurality of UPF network elements.

In step S703, the SMF network element determines an AI service execution policy according to the attribute information of the plurality of UPF network elements and the AI service request message.

In step S704, the SMF network element controls the target UPF network element to execute the AI service according to the AI service execution policy, where the target UPF network element is one or more of the plurality of UPF network elements.

In step S705, the target UPF network element sends a service execution result of the AI service obtained by executing the AI service according to the AI service execution policy to the SMF network element.

In step S706, the SMF network element sends the service execution result to the UE.

The steps S701 to step S706 in this method are the same as the steps S601 to step S606, so reference may be made to steps S601 to S606 and will not be repeated.

In step S707, the SMF network element receives an acknowledgment message sent by the UE based on the service execution result.

For example, after receiving the service execution result, the UE may send the acknowledgment message to a RAN in response to the service execution result, the RAN forwards the acknowledgment message to the AMF network element, and the AMF network element then forwards the acknowledgment message to the SMF network element, which may be understood as transparently transmitting the acknowledgment message to the SMF network element.

In step S708, in response to the acknowledgment message, the SMF network element releases resources occupied by executing the AI service.

For example, after receiving this acknowledgment message, the SMF network element interacts with this PCU to release the resources occupied by the execution of the AI service, which may, for example, include: releasing the occupation of the target UPF network elements, releasing computing resources occupied by the target UPF network elements in the course of executing the AI service, or other possible resources.

In this way, the corresponding AI service execution policy can be generated for the AI service requested by the UE, and the AI service can be executed by scheduling one or more UPF network elements. This provides a workflow for applying AI services based on the 5G core network, enabling a tight coupling of AI technology with the 5G network.

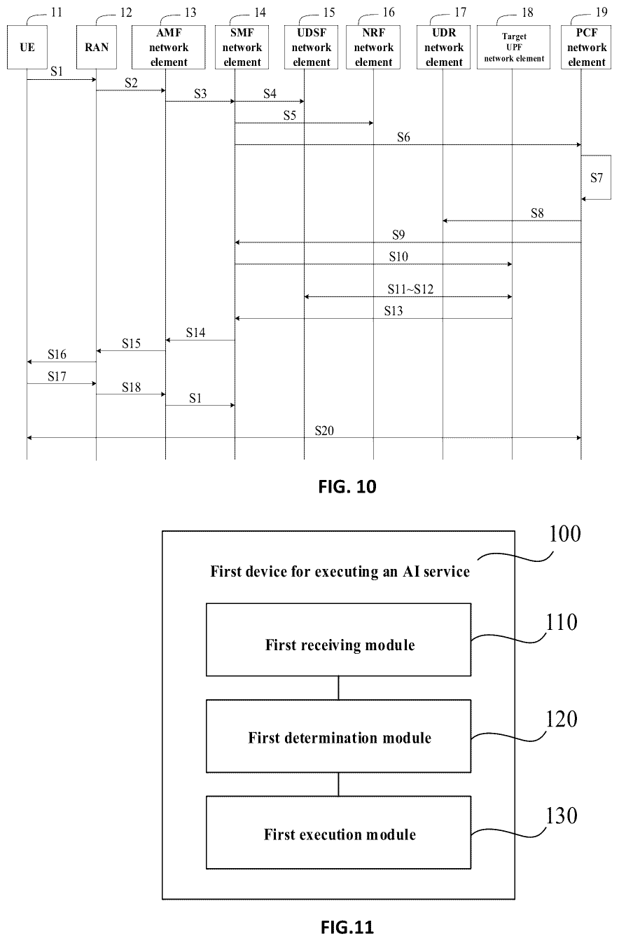

FIG. 10 is a flowchart of a method for executing an AI service according to an example. As shown in FIG. 10, the method for executing an AI service includes the following steps.

In step S1, a UE 11 sends an AI service request message to a RAN 12. The content of the AI service request message may refer to step S501 and will not be repeated.

In step S2, the RAN 12 forwards the AI service request message to an AMF network element 13.

In step S3, the AMF network element 13 forwards the AI service request message to an SMF network element 14.

In step S4, the SMF network element 14 stores AI data in the AI service request message in a UDSF network element 15.

Alternatively, in another implementation, the AI data in the AI service request message may also be stored in the UDSF network element 15 by the AMF network element 13 in step S3 (not shown in FIG. 10).

In step S5, the SMF network element 14 obtains attribute information of a plurality of UPF network elements by querying an NRF network element 16. The attribute information of the UPF network element may refer to the step S502 and will not be repeated.

In step S6, the SMF network element 14 sends the attribute information of the plurality of UPF network elements and the AI service request message to a PCF network element 19.

In step S7, the PCF network element 19 determines an AI service execution policy according to the attribute information of the plurality of UPF network elements and the AI service request message. The method of the PCF network element 19 determining the AI service execution policy may refer to the step S503 and will not be repeated.

In step S8, the PCF network element 19 stores the AI service execution policy in a UDR network element 17.

In step S9, the PCF network element 19 sends the AI service execution policy to the SMF network element 14.

Step S8 and step S9 may be executed in either order or at the same time.

In step S10, the SMF network element 14 establishes a connection with a target UPF network element 18 for executing the AI service, and sends the AI service execution policy to the target UPF network element 18 for executing the AI service.

In step S11, the target UPF network element 18 invokes AI data stored in the UE from the UDSF network element 15.

In step S12, the target UPF network element 18 executes the AI service based on the AI service execution policy to obtain a service execution result. The method of the UPF network element executing the AI service may refer to the step S504 and will not be repeated.

In step S13, the target UPF network element 18 sends the service execution result to the SMF network element 14.

In step S14, the SMF network element 14 sends the service execution result to the AMF network element 13.

In step S15, the AMF network element 13 forwards the service execution result to a RAN 12.

In step S16, the RAN 12 forwards the service execution result to the UE 11.

In step S17, the UE 11 receives the service execution result and then sends an acknowledgment message as a reply to the RAN 12.

In step S18, the RAN 12 forwards the acknowledgment message to the AMF network element 13.

In step S19, the AMF network element 13 forwards the acknowledgement message to the SMF network element 14.

In step S20, the SMF network element 14 receives the message and then releases resources involved in the AI service. For example, the method for releasing the resources may refer to the step S708 and will not be repeated.

In this way, the corresponding AI service execution policy can be generated for the AI service requested by the UE, and the AI service can be executed by scheduling one or more UPF network elements. This provides a workflow for applying AI services based on the 5G core network, enabling a tight coupling of AI technology with the 5G network.

FIG. 11 is a block diagram of a device for executing an AI service according to an example. The device for executing an AI service is applied to an SMF network element. Referring to FIG. 11, a first device 100 for executing an AI service includes a first receiving module 110, a first determination module 120, and a first execution module 130.

The first receiving module 110 is configured to receive an AI service request message, where the AI service request message is configured to indicate an AI service requested by a UE.

The first determination module 120 is configured to determine an AI service execution policy according to attribute information of a plurality of UPF network elements and the AI service request message.

The first execution module 130 is configured to control a target UPF network element to execute the AI service according to the AI service execution policy, where the target UPF network element is one or more of the plurality of UPF network elements.

Optionally, the first determination module 120 may include: an obtaining sub-module, configured to obtain the attribute information of the plurality of UPF network elements; a first sending sub-module, configured to send the attribute information of the plurality of UPF network elements and the AI service request message to a PCF network element; and a first receiving sub-module, configured to receive the AI service execution policy sent by the PCF network element.

Optionally, the obtaining submodule is configured to: obtain the attribute information of the plurality of UPF network elements from an NRF network element.

Optionally, the AI service execution policy may include a PCC rule. The PCC rule includes at least one of an identifier of the PCC rule, an identifier of the target UPF assigned to the AI service, or a priority of the target UPF network element.

Optionally, the first receiving module 110 is configured to: receive the AI service request message forwarded by an AMF network element, where the AI service request message is sent by the UE to the AMF network element via a RAN.

Optionally, the first execution module 130 includes: a second sending sub-module, configured to send the AI service execution policy to the target UPF network elements; and a second receiving sub-module, configured to receive a service execution result of the AI service sent by the target UPF network elements, where the service execution result is generated by the UPF network element executing the AI service based on the AI service execution policy.

Optionally, the target UPF network elements include a primary UPF network element and secondary UPF network element(s). The second receiving submodule is configured to: receive the service execution result sent by the primary UPF network element, where the service execution result is obtained by aggregating an execution result of the primary UPF network element and execution result(s) of the secondary UPF network element(s).

Optionally, the first device 100 for executing an AI service may further include: a sending module, configured to send the service execution result to the AMF network element, where the service execution result is configured for the AMF network element to forward the service execution result to the UE via the RAN.

Optionally, the first device 100 for executing an AI service may further include: a resource management module.

The first receiving module 110 is configured to receive an acknowledgment message sent by the UE based on the service execution result.

The resource management module is configured to release resources occupied by the AI service in response to the acknowledgment message.

In this way, the corresponding AI service execution policy can be generated for the AI service requested by the UE, and the AI service can be executed by scheduling one or more UPF network elements. This provides a workflow for applying AI services based on the 5G core network, enabling a tight coupling of AI technology with the 5G network.

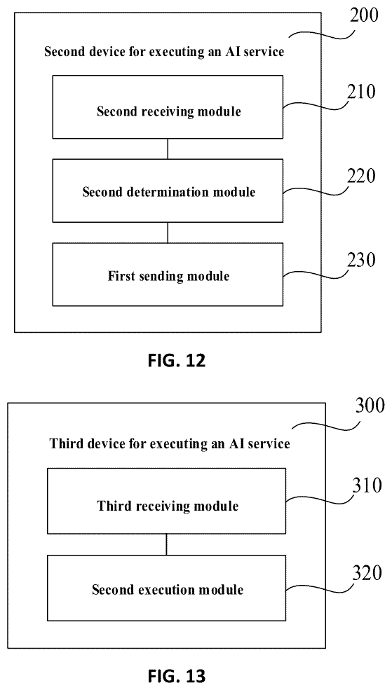

FIG. 12 is a block diagram of a device for executing an AI service according to an example. The device for executing an AI service is applied to a PCF network element. Referring to FIG. 12, a second device 200 for executing an AI service includes a second receiving module 210, a second determination module 220, and a first sending module 230.

The second receiving module 210 is configured to receive attribute information of a plurality of UPF network elements sent by an SMF network element and an AI service request message of a UE, where the AI service request message is configured to indicate an AI service requested by the UE.

The second determination module 220 is configured to determine an AI service execution policy according to the attribute information of the plurality of UPF network elements and the AI service request message.

The first sending module 230 is configured to send the AI service execution policy to the SMF network element, where the AI service execution policy is configured for instructing the SMF network element to control a target UPF network element to execute the AI service according to the AI service execution policy, and the target UPF network element is one or more of the plurality of UPF network elements.

Optionally, the AI service execution policy includes a PCC rule. The PCC rule includes at least one of an identifier of the PCC rule, an identifier of the target UPF assigned to the AI service, or a priority of the target UPF network element.

Optionally, the attribute information of the UPF network element at least includes an AI service supported by the UPF network element, and the AI service request message at least includes an AI service identifier and an AI service type.

The second determination module 220 is configured to: determine, according to AI services supported by the plurality of UPF network elements, at least one target UPF network element from the plurality of UPF network elements that matches the AI service identifier and the AI service type; and determine a priority of the at least one target UPF network element according to the AI service supported by the at least one target UPF network element.

In this way, the corresponding AI service execution policy can be generated for the AI service requested by the UE, and the AI service can be executed by scheduling one or more UPF network elements. This provides a workflow for applying AI services based on the 5G core network, enabling a tight coupling of AI technology with the 5G network.

FIG. 13 is a block diagram of a device for executing an AI service according to an example. The device for executing an AI service is applied to a UPF network element. Referring to FIG. 13, a third device 300 for executing an AI service includes a third receiving module 310 and a second execution module 320.

The third receiving module 310 is configured to receive an AI service execution policy sent by an SMF network element, where the AI service execution policy is determined by the SMF network element according to attribute information of a plurality of UPF network elements and an AI service request message, and the AI service request message is configured to indicate an AI service requested by a UE.

The second execution module 320 is configured to execute the AI service according to the AI service execution policy.

Optionally, the UPF network element is a primary UPF network element among the plurality of UPF network elements for executing the AI service execution policy. The second execution module 320 is configured to: assign the AI service execution policy to the plurality of UPF network elements, where the AI service execution policy is configured to instruct the plurality of target UPF network elements to execute the AI service respectively according to the assigned AI service execution policy; receive an execution result obtained by a secondary UPF among the plurality of UPF network elements executing the AI service according to the AI service execution policy; and obtain a service execution result of the AI service by aggregating an execution result of the primary UPF network element and an execution result of the secondary UPF network element.

Optionally, the AI service request message includes AI data for the execution of the AI service. The second execution module 320 is configured to: obtain the AI data from a UDSF network element, where the AI data is stored in the UDSF network element by the SMF network element after the AI service request message is sent to the SMF network element; or the AI data is stored in the UDSF network element by the AMF network element after the AI service request message is sent to the AMF network element; and execute the AI service according to the AI service execution policy and the AI data.

In this way, the corresponding AI service execution policy can be generated for the AI service requested by the UE, and the AI service can be executed by scheduling one or more UPF network elements. This provides a workflow for applying AI services based on the 5G core network, enabling a tight coupling of AI technology with the 5G network.

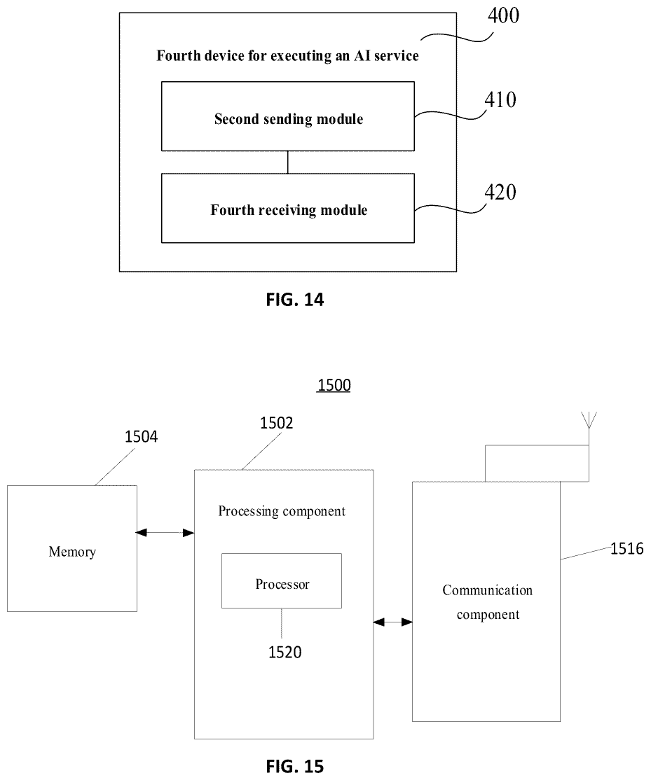

FIG. 14 is a block diagram of a device for executing an AI service according to an example. The device for executing an AI service is applied to a UE. Referring to FIG. 14, a fourth device 400 for executing an AI service includes a second sending module 410 and a fourth receiving module 420.

The second sending module 410 is configured to send an AI service request message to an SMF network element, where the AI service request message is configured to indicate an AI service requested by the UE, the AI service request message is configured to instruct the SMF network element to determine an AI service execution policy according to attribute information of a plurality of UPF network elements and the AI service request message and control a target UPF network element to execute the AI service according to the AI service execution policy, and the target UPF network element is one or more of the plurality UPF network elements.

The fourth receiving module 420 is configured to receive a service execution result of the AI service sent by the SMF network element.

Optionally, the second sending module 410 is configured to: send the AI service request message to an AMF network element via a RAN, where the AI service request message is configured for the AMF network element to forward the AI service request message to the SMF network element.

Optionally, the fourth receiving module 420 is configured to: receive, via the RAN, the service execution result forwarded by the AMF network element, where the service execution result is generated by the target UPF network element executing the AI service and sent to the SMF network element.

In this way, the corresponding AI service execution policy can be generated for the AI service requested by the UE, and the AI service is executed by scheduling one or more UPF network elements. This provides a workflow for applying AI services based on the 5G core network, enabling a tight coupling of AI technology with the 5G network.

With respect to the devices in the foregoing embodiments, the specific manner in which each module performs the operation has been described in detail in the embodiments of the methods, and a detailed description will not be repeated here.

A non-transitory computer-readable storage medium storing computer program instructions thereon is further provided according to an embodiment of the present disclosure. The computer program instructions, when executed by a processor, implement the steps of the methods for executing an AI service provided in the present disclosure.

An SMF network element is further provided according to an embodiment of the present disclosure. The SMF network element includes a processor; and a memory that stores processor-executable instructions. The processor is configured to perform the steps of the method for executing an AI service provided in the present disclosure when executing the executable instructions.

A PCF network element is further provided according to an embodiment of the present disclosure. The PCF network element includes a processor; and a memory that stores processor-executable instructions. The processor is configured to perform the steps of the method for executing an AI service provided in the present disclosure when executing the executable instructions.

An UPF network element is further provided according to an embodiment of the present disclosure. The UPF network element includes a processor; and a memory that stores processor-executable instructions. The processor is configured to perform the steps of the method for executing an AI service provided in the present disclosure when executing the executable instructions.

A UE is further provided according to an embodiment of the present disclosure. The UE includes a processor; and a memory that stores processor-executable instructions. The processor is configured to perform the steps of the method for executing an AI service provided in the present disclosure when executing the executable instructions.

FIG. 15 is a block diagram of a device for executing an AI service according to an example. For example, the device 1500 for executing an AI service may be the UE, such as a mobile phone, a computer, a digital broadcast terminal, a message transceiver device, a game console, a tablet device, a medical device, a fitness device, or a personal digital assistant, etc. and may also be any of the SMF network element, PCF network element, or UPF network element.

Referring to FIG. 15, the device 1500 for executing the AI service may include one or more of the following components: a processing component 1502, a memory 1504, and a communication component 1516.

The processing component 1502 generally controls the overall operation of the device 1500 for executing the AI service, such as operations associated with display, telephone calls, data communications, camera operations, and recording operations. The processing component 1502 may include one or more processors 1520 to execute instructions, to complete all or part of the steps of the method for executing an AI service described. In addition, the processing component 1502 may include one or more modules to facilitate interaction between the processing component 1502 and other components. For example, the processing component 1502 may include a multimedia module to facilitate interaction between a multimedia component 1508 and the processing component 1502.

The memory 1504 is that stores various types of data to support operations in the device 1500 for executing the AI service. Examples of such data include instructions for any application or method operating on the device 1500 for executing the AI service, contact data, phone book data, messages, pictures, videos, etc. The memory 1504 may be implemented by any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The communication component 1516 is configured to facilitate communications, wired or wirelessly, between the device 1500 for executing the AI service and other devices. The device 1500 for executing the AI service may access a wireless network based on a communication standard, such as WiFi, 2G, or 3G, or a combination thereof. In an example, the communication component 1516 receives a broadcast signal or broadcast-related information from an external broadcast management system via a broadcast channel. In an example, the communication component 1516 further includes a near field communication (NFC) module to facilitate short-range communications. For example, the NFC module may be implemented based on radio frequency identification (RFID) technology, infrared data association (IrDA) technology, ultra-wideband (UWB) technology, Bluetooth (BT) technology, and other technologies.

In an example, the device 1500 for executing the AI service may be implemented by one or more application-specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components to execute the methods for executing an AI service.

In an example, a non-transitory computer-readable storage medium including instructions is also provided, such as a memory 1504 including instructions, which may be executed by a processor 1520 of the device 1500 for executing the AI service to accomplish the methods for executing an AI service. For example, the non-temporary computer-readable storage medium may be an ROM, a random access memory (RAM), a compact disc read-only memory (CD-ROM), a magnetic tape, a floppy disk, an optical data storage device, etc.

In addition to being an independent electronic device, any of the devices may also be a part of an independent electronic device. For example, in an embodiment, the device may be an integrated circuit (IC) or a chip. The integrated circuit may be one IC or a collection of a plurality of ICs. The chip may include, but is not limited to, the following types: a GPU (Graphics Processing Unit), a CPU (Central Processing Unit), a FPGA (Field Programmable Gate Array), a DSP (Digital Signal Processor), an ASIC (Application Specific Integrated Circuit), a SOC (System on Chip, SoC), etc. The integrated circuit or chip may be used to execute executable instructions (or code) to implement the methods for executing an AI service. The executable instructions may be stored in the integrated circuit or chip, or may be obtained from other apparatuses or devices. For example, the integrated circuit or chip includes a processor, a memory, and an interface for communication with other apparatuses/devices. The executable instructions may be stored in the processor. The executable instructions, when executed by the processor, implement the methods for executing an AI service. Alternatively, the integrated circuit or chip may receive the executable instructions through the interface and transmit same to the processor for execution, so as to implement the methods for executing an AI service.

A communication system is further provided according to an embodiment of the present disclosure. The communication system includes the SMF network element, PCF network element, UPF network element, and UE, (such as those elements and UE shown in FIG. 10).

In an embodiment, the SMF network element may include the first device 100 for executing an AI service, the PCF network element may include the second device 200 for executing an AI service, the UPF network element may include the third device 300 for executing an AI service, and the UE may include the fourth device 400 for executing an AI service.

Optionally, the communication system may also include the RAN, AMF network element, NRF network element, UDSF network element, and UDR described herein (for example, as shown in FIG. 10, but not limited to that figure). The functions performed by the RAN, the AMF network element, the NRF network element, the UDSF network element, and the UDR may refer to the embodiments shown in FIG. 5 to FIG. 10 and will not be repeated.

A communication system is further provided according to another embodiment of the present disclosure. The communication system includes the SMF network element, PCF network element, UPF network element, and UE.

The SMF network element is configured to execute the method for executing an AI service shown in FIG. 1. The PCF network element may be configured to execute the method for executing an AI service shown in FIG. 2. The UPF network element may be configured to execute the method for executing an AI service shown in FIG. 3. The UE may be configured to execute the method for executing an AI service shown in FIG. 4.

Optionally, the communication system may also include the RAN, AMF network element, NRF network element, UDSF network element, and UDR.

The functions performed by the SMF network element, the PCF network element, the UPF network element, the UE, the RAN, the AMF network element, the NRF network element, the UDSF network element, and the UDR may refer to the embodiments shown in FIG. 5 to FIG. 10 and will not be repeated.

In another example, a computer program product is also provided. The computer program product includes a computer program capable of being executed by a programmable apparatus/device. The computer program has a code portion for executing the methods for executing an AI service when executed by the programmable apparatus/device.

The technical solutions provided in the embodiments of the present disclosure can include the following beneficial effects.

In the technical solutions, the UE sends an AI service request message to the SMF network element, where the AI service request message is configured to indicate the AI service requested by the UE; and based on the received AI service request message and the attribute information of the plurality of UPF network elements, the SMF network element determines an AI service execution policy for executing the AI service, determines one or more of the plurality of UPF network elements as the target UPF network element(s), and executes the AI service by the target UPF network element(s) according to the AI service execution policy. In this way, the corresponding AI service execution policy can be generated for the AI service requested by the UE, and the AI service can be executed by scheduling one or more UPF network elements. This provides a workflow for applying AI services based on the 5G core network, enabling a tight coupling of AI technology with the 5G network.

Other embodiments of the present disclosure will be readily conceivable to those skilled in the art from consideration of the specification and practice the present disclosure. This application is intended to cover any variations, uses, or adaptations of the present disclosure, which follow the general principles of the present disclosure and include common knowledge or customary technical means in the technical field not disclosed in the present disclosure. It is intended that the specification and examples are considered as exemplary merely, with a true scope and spirit of the present disclosure being indicated by the following claims.

It should be understood that the present disclosure is not limited to the exact construction that has been described and illustrated in the accompanying drawings, and that various modifications and changes may be made without departing from the scope of the present disclosure. The scope of the present disclosure is merely limited by the appended claims.

1. A method for executing an artificial intelligence (AI) service performed by a session management function (SMF) network element, wherein the method comprises:
receiving an AI service request message, wherein the AI service request message is configured to indicate the AI service requested by a user equipment (UE);
determining an AI service execution policy according to attribute information of a plurality of user plane function (UPF) network elements and the AI service request message; and
controlling a target UPF network element to execute the AI service according to the AI service execution policy, wherein the target UPF network element is one or more of the plurality of UPF network elements.

2. The method according to claim 1, wherein determining the AI service execution policy according to the attribute information of the plurality of UPF network elements and the AI service request message comprises:
obtaining the attribute information of the plurality of UPF network elements;
sending the attribute information of the plurality of UPF network elements and the AI service request message to a policy control function (PCF) network element; and
receiving the AI service execution policy sent by the PCF network element.

3. The method according to claim 2, wherein obtaining the attribute information of the plurality of UPF network elements comprises:
obtaining the attribute information of the plurality of UPF network elements from a network repository function (NRF) network element.

4. The method according to claim 1, wherein the AI service execution policy comprises a policy control and charging (PCC) rule, and the PCC rule comprises at least one of an identifier of the PCC rule, an identifier of the target UPF network element assigned to the AI service, or a priority of the target UPF network element.

5. The method according to claim 1, wherein receiving the AI service request message comprises:
receiving the AI service request message forwarded by an access and mobility management function (AMF) network element, wherein the AI service request message is sent by the UE to the AMF network element via a radio access network (RAN).

6. The method according to claim 1, wherein controlling the target UPF network element to execute the AI service according to the AI service execution policy comprises:
sending the AI service execution policy to the target UPF network element; and
receiving a service execution result of the AI service sent by the target UPF network element, wherein the service execution result is generated by the a UPF network element executing the AI service based on the AI service execution policy of the plurality of UPF network elements.

7. The method according to claim 6, wherein the target UPF network element comprises a primary UPF network element and a secondary UPF network element, and receiving the service execution result sent by the target UPF network element comprises:
receiving the service execution result sent by the primary UPF network element, wherein the service execution result is obtained by the primary UPF network element aggregating an execution result of the primary UPF with an execution result of the secondary UPF network element.

8. The method according to claim 6, further comprising:
sending the service execution result to the an access and mobility management function (AMF) network element, wherein the service execution result is configured for the AMF network element to forward the service execution result to the UE via a radio access network (RAN).

9. The method according to claim 6, further comprising:
receiving an acknowledgment message sent by the UE based on the service execution result; and
releasing resources occupied by executing the AI service in response to the acknowledgment message.

10. The method according to claim 2, wherein receiving the AI service execution policy sent by the PCF network element comprises:
receiving the AI service execution policy determined by the PCF network element according to the attribute information of the plurality of UPF network elements and the AI service request message, and
wherein the AI service execution policy is configured to instruct the SMF network element to control the target UPF network element to execute the AI service according to the AI service execution policy.

11. (canceled)

12. The method according to claim 10, wherein the attribute information of the UPF network element at least comprises an AI service supported by the UPF network element, and the AI service request message at least comprises an AI service identifier and an AI service type; and
wherein the AI service execution policy determined by the PCF network element according to the attribute information of the plurality of UPF network elements and the AI service request message comprises:
determining, by the PCF network element, at least one target UPF network element from the plurality of UPF network elements that matches the AI service identifier and the AI service type according to AI services supported by the plurality of UPF network elements, and
determining, by the PCF network element, a priority of the at least one target UPF network element according to the AI service supported by the at least one target UPF network element.

13. A method for executing an artificial intelligence (AI) service performed by a user plane function (UPF) network element, wherein the method comprises:
receiving an AI service execution policy sent by a session management function (SMF) network element, wherein the AI service execution policy is determined by the SMF network element according to attribute information of a plurality of UPF network elements and an AI service request message, and the AI service request message is configured to indicate the AI service requested by a user equipment (UE); and
executing the AI service according to the AI service execution policy.

14. The method according to claim 13, wherein the UPF network element is a primary UPF network element, from a plurality of target UPF network elements, for executing the AI service execution policy, and executing the AI service according to the AI service execution policy comprises:
assigning the AI service execution policy to the plurality of target UPF network elements, wherein the AI service execution policy is configured to instruct the plurality of target UPF network elements to execute the AI service respectively according to the assigned AI service execution policy;
receiving an execution result obtained by a secondary UPF network element, from the plurality of target UPF network elements, executing the AI service according to the AI service execution policy; and
obtaining a service execution result of the AI service by aggregating an execution result of the primary UPF network element and the execution result of the secondary UPF network element.

15. The method according to claim 13, wherein the AI service request message comprises AI data for executing the AI service, and executing the AI service according to the AI service execution policy comprises:
obtaining the AI data from an unstructured data storage network function (UDSF) network element, wherein the AI data is stored in the UDSF network element by the SMF network element after the AI service request message is sent to the SMF network element; or the AI data is stored in the UDSF network element by the AMF network element after the AI service request message is sent to the AMF network element; and
executing the AI service according to the AI service execution policy and the AI data.

16. A method for executing an artificial intelligence (AI) service performed by a user equipment (UE), wherein the method comprises:
sending an AI service request message to a session management function (SMF) network element,
wherein the AI service request message is configured to indicate an the AI service requested by the UE, and instruct the SMF network element to
determine an AI service execution policy according to attribute information of a plurality of user plane function (UPF) network elements and the AI service request message, and
control a target UPF network element to execute the AI service according to the AI service execution policy, and the target UPF network element is one or more of the plurality UPF network elements; and
receiving a service execution result of the AI service sent by the SMF network element.

17. The method according to claim 16, wherein sending the AI service request message to the SMF network element comprises:
sending the AI service request message to an access and mobility management function (AMF) network element via a radio access network (RAN), wherein the AI service request message is configured for the AMF network element to forward the AI service request message to the SMF network element.

18. The method according to claim 16, wherein receiving the service execution result of the AI service sent by the SMF network element comprises:
receiving the service execution result forwarded by the AMF network element via the RAN, wherein the service execution result is generated by the target UPF network element executing the AI service and sent to the SMF network element.

19-22. (canceled)

23. A session management function (SMF) network element, comprising:
one or more processors; and
a memory that stores processor-executable instructions, wherein
the one or more processors are configured to perform the method for executing the AI service according to claim 1 when executing the processor-executable instructions.

24. (canceled)

25. A user plane function (UPF) network element, comprising:
one or more processors; and
a memory that stores processor-executable instructions, wherein
the one or more processors are configured to perform the method for executing the AL service according to claim 13 when executing the processor-executable instructions.

26. A user equipment (UE), comprising:
one or more processors; and
a memory that stores processor-executable instructions, wherein
the one or more processors are configured to perform the method for executing the AI service according to claim 16 when executing the processor-executable instructions.

27-28. (canceled)
